(19) United States
(12) Patent Application Publication
(10) Pub. No.: US 2006/0081300 A1
(43) Pub. Date: Apr. 20, 2006

(54) Apparatus for capping plumbing vent pipes during pressure testing

(76) Inventor: Gregory P. Schmalz, Elmira (CA)

Correspondence Address: BERESKIN AND PARR, 40 KING STREET WEST, BOX 401, TORONTO, ON, M5H 3Y2, CA

(21) Appl. No.: 10/963,691

(22) Filed: Oct. 14, 2004

(51) Int. Cl. F16L 55/10

(52) U.S. Cl. 138/90; 138/89

(57) ABSTRACT

An apparatus for capping a plumbing vent pipe during pressure testing of a plumbing system for a house or other building includes a vent test cap and a removal rod. The vent test cap has an enclosure portion and an engagement portion. The enclosure portion is shaped for sealingly enclosing an open top end of a vent pipe during testing of a plumbing system. An engagement portion extends upwardly from the enclosure portion and includes at least one socket. A user may use the removal rod to and apply an upwardly directed force to the engagement portion, so as to remotely remove the vent test cap from the vent pipe, without having to climb on the roof of the building.

### FIELD OF THE INVENTION

The present invention relates to an apparatus for capping plumbing vent pipes during pressure testing.

### BACKGROUND OF THE INVENTION

Plumbing systems for houses and other buildings are typically vented through a plumbing vent pipe extending above the roof of the building. In many jurisdictions, building codes require that plumbing systems be tested for leaks using a pressure testing procedure before a building is approved for occupancy. This pressure testing procedure typically involves the steps of placing a plastic vent test cap on the vent pipe, sealing the test cap to the vent pipe using a sealant, and pressurizing the plumbing system to determine if there are leaks. Following the completion of the pressure testing procedure, the vent test cap is removed, typically by prying off the test cap with the claw end of a hammer or a crowbar, so that the plumbing system may be properly vented through the vent pipe.

Removal of the vent test cap typically requires a tester to climb up onto a ladder and in some cases the roof itself. This entails a risk of serious injury, as the tester could fall from the roof or ladder while removing the vent test cap. This risk is significant, particularly in the case of houses having high, steep roofs. It is therefore necessary or desirable for the tester to take safety precautions, such as the use of fall-arrest or travel-restraint systems. Climbing onto the roof to remove the test cap is also a time consuming exercise, which adds to the cost of the testing procedure.

There exist a few systems that allow a user to remove a vent test cap from a vent pipe without climbing on the roof. One such system utilizes an inflatable bladder which is placed in a plumbing clean-out located in the building attic, and subsequently removed after testing. However, this system typically requires a tester to climb a ladder into a restricted attic space, which involves time and expense, as well as discomfort to the tester. Also, such systems offer little or no visibility of the vent test cap from outside the building, thus making verification of the presence of the cap from outside the building more difficult.

U.S. Pat. No. 5,520,219 discloses another system for remotely removing a vent test cap from a plumbing system without requiring that a tester climb on the roof of the building. This system includes a vent test cap comprising a cover and a bottom portion connected together by a frangible neck. When a force is applied to the cover, the frangible neck breaks, separating the cover and opening the vent pipe to allow ventilation. Force may be applied to the cover by using an extension tool to engage either an annular groove or a hook on the cover. However, engagement of an annular groove or hook may require great precision in positioning of the extension tool. In addition, only the cover of the vent test cap is actually removed. The bottom portion remains in place and may have to be removed for subsequent tests.

There is accordingly a need for an improved apparatus for capping a vent pipe during pressure testing, which can be easily and remotely removed following the testing.

### SUMMARY OF THE INVENTION

In a first aspect, the present invention provides apparatus for capping plumbing vent pipes during pressure testing, comprising a vent test cap having an enclosure portion and an engagement portion. The enclosure portion is shaped for sealingly enclosing an open top end of a vent pipe during pressure testing of a plumbing system. The engagement portion extends upwardly from the enclosure portion for engaging a remote end of an removal rod. The engagement portion has at least one socket shaped for engaging the remote end of the removal rod. A user handling the removal rod may remove the enclosure portion from the vent pipe by applying a force having an upwardly directed force component to the engagement portion with the removal rod.

In one embodiment, the engagement portion of the vent test cap comprises a central core, a plurality of spaced walls extending radially outwardly from the core and a top covering at least part of the core and the spaced walls, the spaced walls having side surfaces and the top having a lower surface, the lower surface of the top and the side surfaces forming the at least one socket. In another embodiment, the engagement portion has a hollow core, shaped to allow the removal rod to be passed therethrough. In yet another embodiment, the engagement portion comprises an asymmetric body having a protruding lobe which extends outwardly from an outside edge of the enclosure portion. In this embodiment, the at least one socket comprises an offset socket located within the protruding lobe.

In another aspect, the present invention provides an apparatus for capping plumbing vent pipes during pressure testing, comprising a vent test cap and a removal rod. The vent test cap has an enclosure portion for sealingly enclosing an open top end of a vent pipe during pressure testing of a plumbing system. The vent test cap also has an engagement portion integrally connected to and extending upwardly from the enclosure portion. The engagement portion has at least one socket. The removal rod has a remote end for applying a force, to the engagement portion and a handle portion allowing a user to handle the removal rod to engage with the remote end of the rod to apply the force having an upwardly directly force component to the engagement portion, thereby removing the test cap after the pressure testing is completed.

### BRIEF DESCRIPTION OF THE DRAWINGS

For a better understanding of the present invention, reference will now be made, by way of example only, to the accompanying drawings, in which:

FIG. 1 is a perspective view of a first embodiment of vent test capping apparatus made in accordance with the present invention;

FIG. 2 is a side sectional view of the vent test capping apparatus of FIG. 1;

FIG. 3 is a top plan view of the vent test capping apparatus of FIG. 1;

FIG. 4 is a side sectional view of vent test capping apparatus of FIG. 1 showing removal of the vent test cap in the process of being removed by with the removal rod;

FIG. 5 is a perspective view of a second embodiment of vent test capping apparatus made in accordance with the present invention;

FIG. 6 is a side sectional view of the of the vent test capping apparatus of FIG. 5;

FIG. 7 is a top plan view of the vent test capping apparatus of FIG. 5;

FIG. 8 is a perspective view of a third embodiment of vent test capping apparatus made in accordance with the present invention;

FIG. 9 is a top plan view of the test capping apparatus of FIG. 8;

FIG. 10 is a side sectional view of the vent test capping apparatus of FIG. 8;

FIG. 11 is a perspective view of a fourth embodiment of vent test capping apparatus made in accordance with the present invention;

FIG. 12 is a top plan view of the vent test capping apparatus of FIG. 11;

FIG. 13 is a side sectional view of the vent test capping apparatus of FIG. 11; and

FIG. 14 is a side sectional view of a variant of the first embodiment of a vent test cap made in accordance with the present invention.

### DETAILED DESCRIPTION OF THE INVENTION

The present invention relates to an apparatus for capping plumbing vent pipes during pressure testing, and in particular, to a vent test cap shaped to be remotely removed by a removal rod. In general, the vent test cap is placed upon an open top end of a vent pipe and a sealant is applied for sealingly engaging the vent test cap and the vent pipe. The plumbing system is then pressurized to conduct the pressure test. After the pressure test is completed, the vent test cap is remotely removed with the removal rod.

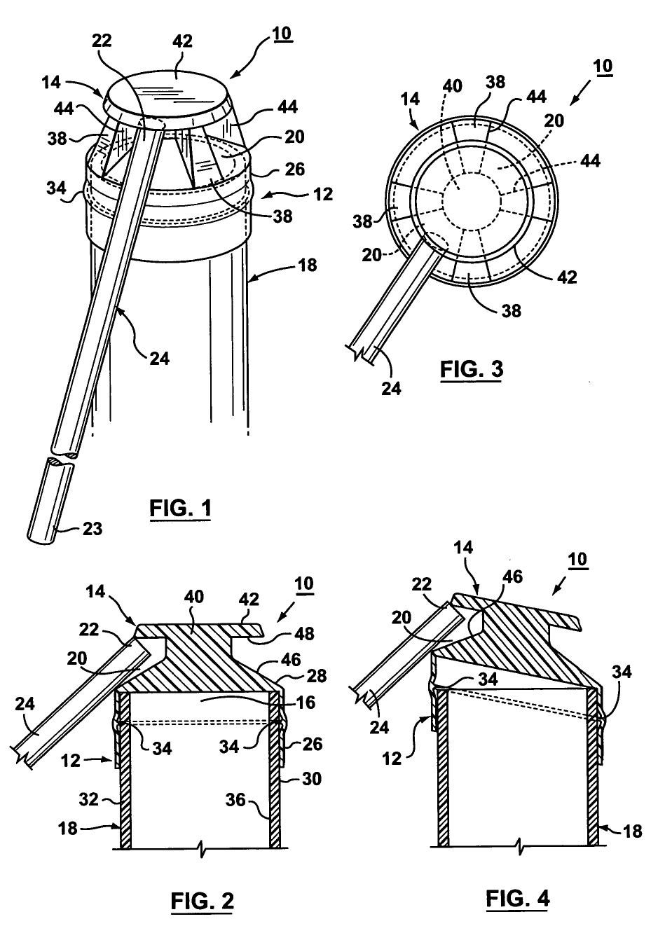

Referring now to FIGS. 1-4, illustrated therein is a first embodiment of the capping apparatus of the present invention, comprising vent test cap 10 and removal rod 24. Vent test cap 10 comprises enclosure portion 12 and engagement portion 14 extending upwardly from enclosure portion 12. Enclosure portion 12 is shaped to sealingly enclose an open top end 16 of vent pipe 18 during pressure testing. Removal rod 24 has a handle end 23 and a remote end 22. Engagement portion 14 contains a number of cavities or sockets 20 shaped for receiving remote end 22 of removal rod 24. Handle end 23 may be handled by a user to apply a force having an upwardly directed force component to engagement portion 14, to remove vent test cap 10 from vent pipe 18.

Enclosure portion 12 of vent test cap 10 comprises side wall 26 and cover 28. Side wall 26 is cylindrically shaped and dimensioned to sealingly engage wall outside surface 30 of wall 32 of standard cylindrical vent pipe 18. Cover 28 extends across enclosure portion 12 to side wall 26 to cover open top end 16 of vent pipe 18. When testing is undertaken, a sealing agent is applied for sealing side wall 26 to outside surface 30 of wall 32 of vent pipe 18. Since cover 28 extends across to side wall 26 and covers open top end 16 of vent pipe 18, side wall 26 and cover 28 of enclosure portion 12 sealingly enclose open top end 16 when a sealing agent is applied. Side wall 26 includes sealing ring 34 formed by an annular protrusion extending from a portion of side wall 26 for sealingly engaging outside surface 30 of wall 32.

Since standard vent pipes 18 are typically made of acrylonitrile butadiene styrene (ABS) plastic, vent test cap 10 is preferably made of a non-ABS plastic, so that an ABS sealant can be used to seal test cap 10 to a standard ABS vent pipe 18 during pressure testing. The ABS sealant melts a portion of the surface of vent pipe 18 but not that of engagement portion 14, resulting in a seal that is strong enough to withstand pressure testing, but which may be broken after testing is completed by applying a force having an upwardly directed force component to engagement portion 14.

It will be apparent to one skilled in the art that other materials and sealing agents may be used, provided that the combination of materials for enclosure portion 12, vent pipe 18, and sealing agent create a seal sufficiently strong to withstand pressure testing but which may be removed following testing by application of a force by a user. Other shapes for vent test cap 10, enclosure portion 12, and vent pipe 18 are also possible, provided that enclosure portion 12 is shaped to sealingly engage vent pipe 18. It is not the intention of the inventor to limit the materials used to a particular type of plastic or sealing agent or the shape of vent pipe 18, vent test cap 10, enclosure portion 12, or engagement portion 14 to a cylindrical shape.

Engagement portion 14 is preferably integrally connected to enclosure portion 12. Engagement portion 14 is cylindrical in shape and has a plurality of regularly spaced walls 38 and a solid central core 40. Spaced walls 38 having side surfaces 44 extend radially outwardly from solid central core 40, which is generally cylindrical in shape. Solid central core 40 and a central portion of spaced walls 40 are covered by top 42. Sockets 20 are formed by two opposing side surfaces 44 of adjacent walls 38, lower surface 48 of top 42, upper surface 46 of cover 28, and solid central core 40.

As best shown in FIGS. 3 and 4, upper surface 46 of cover 28 is inclined inwardly to form inclined floor for socket 20, which helps guide remote end 22 of removal rod 24 in an upward direction and facilitate insertion of remote end 22 of removal rod 24 into socket 20 and application of a force having an upwardly directed force component.

As shown, vent test cap 10 comprises four regularly spaced walls 38, which form four sockets 20, which are substantially equal in size. Thus, a user may engage engagement portion 14 by placing remote end 22 removal rod 24 into the most conveniently located socket 20. While, for the embodiment shown, there are four regularly spaced walls 38 which form four sockets 20 of substantially equal size, it will be apparent to one skilled in the art that a different number of spaced walls 38 and sockets 20 are possible and that sockets 20 need not be equal in size. It is not the intention of the inventor to limit the number of sockets 20 to a fixed quantity or the size and shape of sockets 20 to a fixed set of dimensions.

FIG. 4 illustrates the removal of vent test cap 10 using removal rod 24. A user inserts remote end 22 of removal rod 24 into socket 20, and applies a force having an upwardly directed force component to engagement portion 14. This force disengages side wall 26 of enclosure portion 12 from wall 30 of vent pipe 18 and pushes vent test cap 10 in an upwardly direction to remove vent test cap 10 from vent pipe 18.

Removal rod 24 is selected to be of sufficient length to allow a user to engage engagement portion 14 and apply force to remove vent test cap 10 without climbing on the roof. As such, the length of removal rod 24 may vary depending on the height of the roof on which vent pipe 18 is located. Removal rod 24 may be made out of metal, plastic, wood, or any other material that allows a user to apply the force necessary to remotely remove vent test cap 10 by handling removal rod 24. For example, removal rod 24 may comprise, among other things, a length of copper pipe or a wooden stick. It is not the intention of the inventor to limit the removal rod 24 to a fixed length or a specific material.

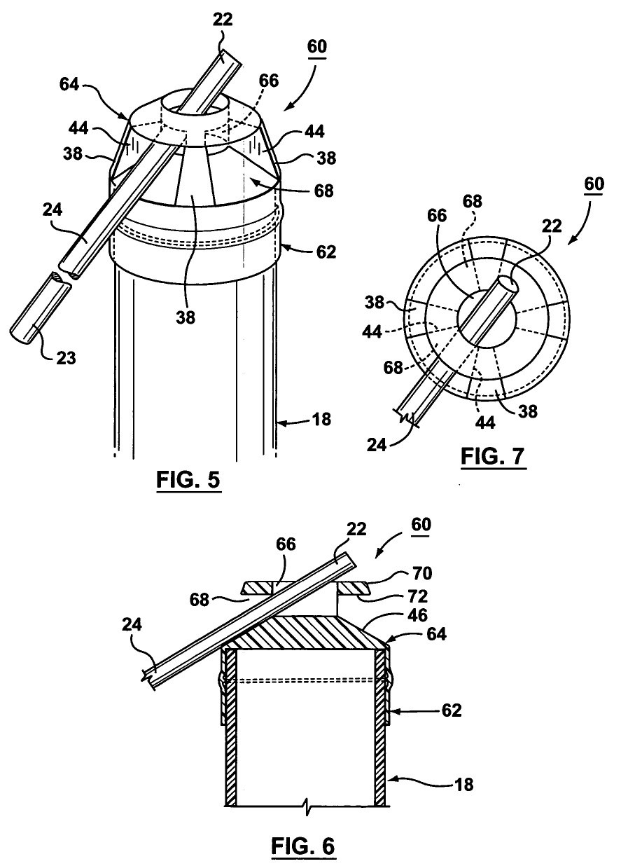

Turning now to FIGS. 5-7, illustrated therein is a second embodiment of the capping apparatus of the present invention, comprising vent test cap 60 and removal rod 24. Vent test cap 60 comprises enclosure portion 62 and an engagement portion 64. Enclosure portion 62 is essentially the same as enclosure portion 12 of the first embodiment of the capping apparatus shown in FIG. 1. Engagement portion 64 is similar to engagement portion 14 of the first embodiment, except that engagement portion 64 has hollow central core 66 which does not form a barrier to prevent removal rod 24 from passing through socket 68. Remote end 22 of removal rod 24 may be inserted through socket 68 and hollow central core 66 allowing the user may to operate the removal rod 24 as a lever to apply a force having an upwardly directed force component to engagement portion 64. As in the case of the first embodiment illustrated in FIG. 1, engagement portion 64 of the second embodiment has four sockets 68 formed by side surfaces 44 of regularly spaced walls 38, lower surface 72 of top 70, and upper surface 46 of cover 28. Upper surface 46 of cover 28 is inclined upwardly to guide remote end 22 of removal rod 24 into sockets 68 and facilitate application of an upwardly directed force.

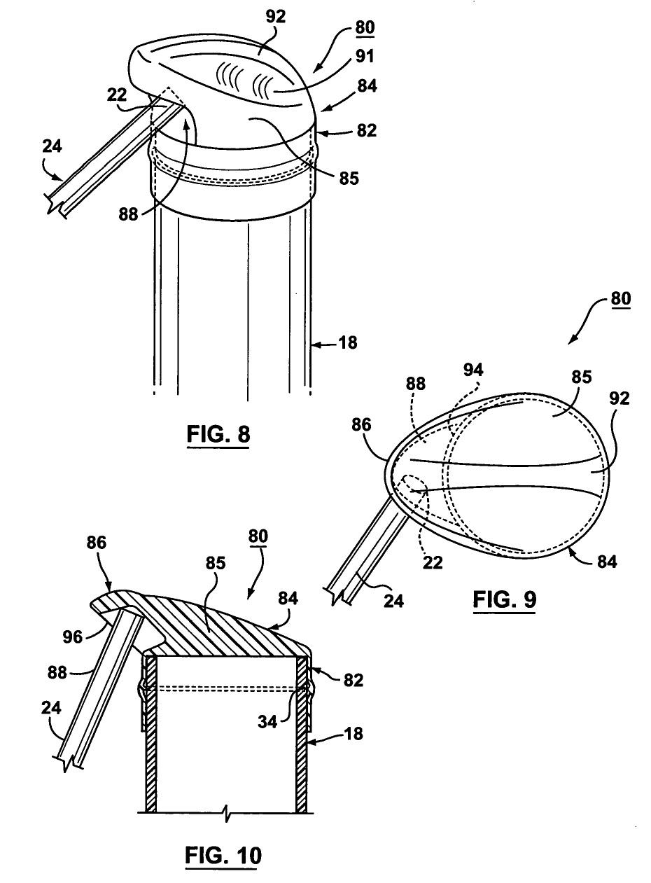

FIGS. 8-10 illustrate capping apparatus made in accordance with a third embodiment of the present invention, comprising vent test cap 80 and removal rod 24. Vent test cap 80 comprises enclosure portion 82 and engagement portion 84. Enclosure portion 82 is shaped like enclosure portion 12 of the first embodiment. Engagement portion 84 comprises an asymmetric body 85 having a protruding lobe 86 which extends laterally outwardly from edge 94 of enclosure portion 82. Lobe 86 has a single offset cavity or socket 88 shaped for engaging remote end 22 of removal rod 24. The upper surface 96 and lower surface 98 of interior wall of offset socket 88 are inclined upwardly to help guide remote end 22 of removal rod 24 into socket 88 and facilitate the application of a force having an upwardly directed force component to engagement portion 84 to remove vent test cap 80. Body 85 has side indentations 91 and elevated ridge 92 that may be grasped by user to facilitate manipulation of vent test cap 80 when placing vent test cap 80 on vent pipe 18.

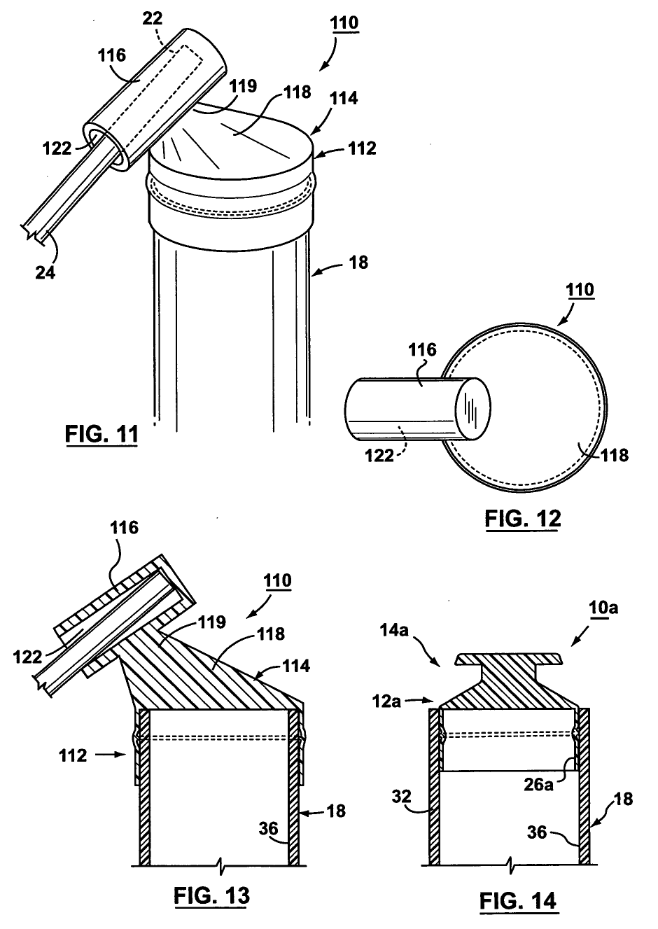

FIGS. 11-13 illustrate capping apparatus made in accordance with a fourth embodiment of the present invention, comprising vent test cap 110 and removal rod 24. Vent test cap 110 comprises enclosure portion 112 and engagement portion 114. Enclosure portion 112 is similar to enclosure portion 12. Engagement portion 114 comprises an asymmetric body 118 having a neck portion 119, and an upwardly inclined tubular portion 116 connected thereto, having tubular socket 122 dimensioned to receive remote end 22 of removal rod 24. A user may remove vent test cap 110 from vent pipe 18 by inserting the remote end 22 of removal rod 24 into tubular socket 122 and applying a force having an upwardly directed force component to tubular portion 116 of asymmetric body 118.

Turning now to FIG. 14, illustrated therein is a variant of the first embodiment of the present invention, comprising vent test cap 10a having enclosure portion 12a and engagement portion 14a. Engagement portion 14a is shaped like engagement portion 14 of the first embodiment illustrated in FIG. 1. As shown, enclosure portion 12a is similar to enclosure portion 12 of the first embodiment shown in FIG. 1, except that side wall 26a is dimensioned to sealingly engage inside surface 36 of wall 32 of vent pipe 18. As one skilled in the art will appreciate, the second, third and fourth embodiments can be modified in a similar fashion, such that the side wall sealingly engages inside surface 36 of wall 32 of vent pipe 18.

It should be apparent to one skilled in the art that various modifications can be made to the embodiments described herein, without departure from the present invention, the scope of which is defined in the appended claims.

1. Apparatus for capping plumbing vent pipes during pressure testing, comprising a vent test cap, the vent test cap having:
(a) an enclosure portion shaped for sealingly enclosing an open top end of a vent pipe during pressure testing of a plumbing system; and
(b) an engagement portion extending upwardly from the enclosure portion for engaging a remote end of a removal rod, the engagement portion having at least one socket shaped for engaging the remote end, whereby a user handling the removal rod may remove the enclosure portion from the vent pipe by applying a force having an upwardly directed force component to the engagement portion.

2. The apparatus of claim 1, wherein the engagement portion comprises a central core, a plurality of spaced walls extending radially outwardly from the core and a top covering at least part of the core and the spaced walls, the spaced walls having side surfaces and the top having a lower surface, the lower surface of the top and the side surfaces forming the at least one socket.

3. The apparatus of claim 1,
(a) wherein the enclosure portion comprises a side wall shaped for sealingly engaging a wall of the vent pipe, and a cover shaped to extend across the side wall and cover the open top end of the vent test pipe, wherein the cover and the side wall sealingly enclose the open top when a sealing agent is applied to the side wall; and
(b) wherein the engagement portion comprises a central core, a plurality of spaced walls extending radially outwardly from the central core, and a top covering at least a part of the central core and the spaced walls, the spaced walls having side surfaces and the top having a lower surface, the lower surface of the top and the side surfaces of the spaced walls forming the at least one socket.

4. The apparatus of claim 3, wherein the cover of the enclosure portion has an upper surface, the upper surface being inclined upwards for guiding the remote end of the removal rod in an upwardly direction for facilitating the applying of the force having the upwardly directed force component.

5. The apparatus of claim 4, wherein the area of the lower surface of the top is less than the area of the upper surface of the cover and the spaced walls are inclined from the upper surface towards the lower surface, for guiding the remote end of the removal rod in an upwards direction and facilitating the applying of the force having the upward force component.

6. The apparatus of claim 5, wherein the at least one socket comprises a plurality of sockets.

7. The application of claim 6, wherein the spaced walls are regularly spaced and the sockets are substantially equal in size.

8. The apparatus of claim 6, wherein the top is circular in shape and the engagement portion, the enclosure portion, and the vent pipe are cylindrical in shape.

9. The apparatus of claim 3, wherein the central core is covered by the top and the central core is a solid central core of circular shape which forms an internal barrier in the sockets for receiving the force and through which the remote end of the removal rod may not pass when the remote end is inserted into a socket.

10. The apparatus of claim 3, wherein the central core has a hollow central portion shaped to allow the remote end of the removal rod to be inserted into the socket, and passed through the hollow core so the removal rod may be used as a lever to facilitate removal of the test cap.

11. The apparatus of claim 1, wherein the engagement portion comprises a body having a protruding lobe, wherein the protruding lobe extends outwardly from an edge of the enclosure portion, and wherein the at least socket comprises an offset socket located within the protruding lobe.

12. The apparatus of claim 11, wherein the asymmetric body has side indentations and a ridge shaped to be grasped by a user to facilitate placement of the vent test cap on the vent pipe.

13. The apparatus of claim 1, wherein the engagement portion comprises an offset body having an upwardly inclined tubular portion, the tubular portion having a tubular socket shaped for receiving the remote end of the removal rod.

14. The apparatus defined in claim 13, wherein the tubular portion extends over the side of the enclosure portion.

15. The apparatus of claim 3, wherein the side wall of the enclosure portion is dimensioned to sealingly engage an outside wall of the vent pipe.

16. The apparatus of claim 3, wherein the side wall of the enclosure portion is dimensioned to sealingly engage an inside wall of the vent pipe.

17. The apparatus of claim 3, wherein the vent pipe is made of an acrylonitrile butadiene styrene plastic, the enclosure portion is made of a non-acrylonitrile butadiene styrene plastic, and the sealing agent is a sealing agent for an acrylonitrile butadiene styrene plastic, wherein the sealing agent forms a seal that may be disengaged by the applying of the force.

18. The apparatus of claim 3, wherein the enclosure portion and the vent pipe are cylindrical in shape and the side wall of the enclosure portion further comprises a sealing ring, the sealing ring comprising an annular protrusion extending outward from a portion of the side wall for sealingly engaging the wall of the vent pipe for sealing the side wall and the wall of the vent pipe.

19. Apparatus for capping plumbing vent pipes during pressure testing, comprising:
a) a vent test cap comprising an enclosure portion for sealingly enclosing an open top end of a vent pipe during pressure testing of a plumbing system, and an engagement portion integrally connected to and extending upwardly from the enclosure portion, the engagement portion having at least one socket; and
b) a removal rod having a remote end for applying a force to the engagement portion and a handle portion allowing a user may handle the removal rod to engage the socket with the remote end of the rod to apply the force having an upwardly directly force component to thereby remove the vent test cap the engagement portion after the pressure testing is completed.

20. A vent test cap comprising:
a) an enclosure portion of cylindrical shape for sealingly enclosing an open top end of a vent pipe having a cylindrical shape during pressure testing of a plumbing system, the enclosure portion comprising a cover having an upwardly inclined upper surface upper surface, and a side wall shaped for sealingly engaging a surface of a wall of the vent pipe; and
b) an engagement portion having a cylindrical shape extending upwardly from the enclosure portion, the engagement portion comprising a central core, a plurality of inclined radially extending, regularly spaced walls extending radially outwardly from the central core, and a circular top covering at least part of the central core and spaced walls, wherein side surfaces of the spaced walls are connected to the upper surface of the cover of the enclosure portion and the lower surface of the top, to form a plurality of sockets of substantially equal size for engaging a remote end of a removal rod, whereby a user handling the removal rod may remove the enclosure portion from the vent pipe by applying a force having an upwardly directed force component to the engagement portion.
